(19) United States
(12) Patent Application Publication
(10) Pub. No.: US 2023/0152587 A1
(43) Pub. Date: May 18, 2023

(54) AMBIENT LIGHT SENSORS AND CAMERA-BASED DISPLAY ADJUSTMENT IN SMART GLASSES FOR IMMERSIVE REALITY APPLICATIONS

(71) Applicant: Meta Platforms Technologies, LLC, Menlo Park, CA (US)

(72) Inventors: Sebastian Sztuk, Virum (DK); Salvael Ortega Estrada, Cedar Park, TX (US); Johana Gabriela Coyoc Escudero, Union City, CA (US); Scott Jeffrey Woltman, Seattle, WA (US); Igor Markovsky, Campbell, CA (US)

(21) Appl. No.: 17/949,934

(22) Filed: Sep. 21, 2022

Related U.S. Application Data
(60) Provisional application No. 63/280,520, filed on Nov. 17, 2021.
(60) Provisional application No. 63/313,008, filed on Feb. 23, 2022.

(51) Int. Cl. G02B 27/01

(52) U.S. Cl. CPC G02B 27/0172; G02B 2027/0178; G02B 2027/0118; G02B 2027/014

(57) ABSTRACT

A headset for use with immersive reality applications is provided. The headset includes a left eyepiece and a right eyepiece mounted on a frame, a display in at least one of the left eyepiece or the right eyepiece, the display comprising an array of multiple light emitting pixels, an ambient light sensor to measure an amount of ambient light, and a processor configured to control a light intensity of the light emitting pixels based on the amount of ambient light. A method for using the above headset is also provided.

### CROSS-REFERENCE TO RELATED APPLICATIONS

The present disclosure is related to and claims priority under 35 USC § 119(e) to U.S. Provisional Appln. No. 63/280,520 filed on Nov. 17, 2021, entitled AMBIENT LIGHT SENSOR AND CAMERA BASED DISPLAY ADJUSTMENT, to Sebastian SZTUK, et al., and to U.S. Provisional Appln. No. 63/313,008, filed on Feb. 23, 2022, entitled AMBIENT LIGHT SENSORS AND CAMERA-BASED DISPLAY ADJUSTMENT IN SMART GLASSES FOR IMMERSIVE REALITY APPLICATIONS, to Scott J. WOLTMAN et al., the contents of which applications are hereinafter incorporated by reference in their entirety, for all purposes.

### BACKGROUND

### Field

The present disclosure is directed to configuring display settings for different ambient light conditions in smart glasses. More specifically, embodiments as disclosed herein are directed to optimizing display appearance against the environmental scenario wherein a user is embedded.

### Related Art

Smart glasses for use in augmented reality (AR) applications pose the challenge of adapting the brightness and other display features to widely varying environmental conditions. Indeed, the range of external brightness encountered by a user throughout the day, indoors and outdoors, can vary widely, and with it, the level of contrast desired in an AR display. Not only the brightness changes, but also the hue and tonality, as each of the component colors (e.g., Red —R—, Green —G—, and Blue —B—) is affected differently by environmental conditions. Current smart glass displays do not address this challenge appropriately, having just a handful of different configurations with little continuity and adaptability for the wide range of conditions experienced by users.

### SUMMARY

In a first embodiment, a device includes a left eyepiece and a right eyepiece mounted on a frame, a display in at least one of the left eyepiece or the right eyepiece, the display comprising an array of multiple light emitting pixels, an ambient light sensor, a camera, or a combination thereof, to measure an amount of ambient light, and a processor configured to control a light intensity and color profile of the light emitting pixels based on the amount of ambient light.

In a second embodiment, a computer-implemented method includes receiving, from an ambient light sensor, a signal indicative of an amount of ambient light in an environment of a headset, determining a characteristic of a virtual image provided to a user, based on the amount of ambient light in the environment of the headset, and controlling a light intensity of multiple light emitting pixels in a display of the headset, based on the characteristic of the virtual image. The computer-implemented method may also include controlling an appearance of a virtual object based on the amount of ambient light in the environment of the headset.

In a third embodiment, a system includes a memory storing instructions and a processor configured to execute the instructions which, when executed, cause the system to receive, from an ambient light sensor, a signal indicative of an amount of ambient light in an environment of a headset, determine a characteristic of a virtual image provided to a user, based on the amount of ambient light in the environment of the headset, and control a light intensity of multiple light emitting pixels in a display of the headset, based on the characteristic of the virtual image.

In yet another embodiment, a system includes a first means to store instructions and a second means configured to execute the instructions which, when executed, cause the system to receive, from an ambient light sensor, a signal indicative of an amount of ambient light in an environment of a headset, determine a characteristic of a virtual image provided to a user, based on the amount of ambient light in the environment of the headset, and control a light intensity of multiple light emitting pixels in a display of the headset, based on the characteristic of the virtual image.

These and other embodiments will be clear based on the following disclosure.

### BRIEF DESCRIPTION OF THE DRAWINGS

FIG. 1 illustrates a smart glass including an ambient light sensor for enhanced reality applications, according to some embodiments.

FIG. 2 illustrates several configurations of a smart glass with an electronic control for transparency regulation, according to some embodiments.

FIG. 3 illustrates multiple scene-aware adaptive gamma curves for different ambient light configurations in a smart glass, according to some embodiments.

FIG. 4 illustrates a color gamut and chromaticity plot for adjusting a Red, Green, and Blue (RGB) display in a smart glass to a given ambient light configuration, according to some embodiments.

FIG. 5 illustrates a flow chart indicating steps in a method for adjusting an RGB display in a smart glass according to an ambient light configuration, according to some embodiments.

FIG. 6 is a flowchart illustrating steps in a method for controlling a display in a headset based on an ambient light measurement, according to some embodiments.

FIG. 7 is a block diagram illustrating an exemplary computer system with which a headset as in FIG. 1 and the methods of FIGS. 5 and 6 can be implemented, according to some embodiments.

In the figures, elements having the same or similar attributes and features are labeled with the same or similar reference labels, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

As a user of a smart glass transits from the indoors to the outdoors, or from the interior of a vehicle, out, and from early morning, through high noon into the evening and late night, it is expected that the AR display provides a well-balanced, clear, sharp, and comfortable color gamut and brightness.

To resolve the above challenge, smart glasses as disclosed herein include an ambient light sensor (ALS). Accordingly, the display of the smart glass may have adjustable settings that allow brightness, gamma, and white balance adjustment according to an ALS signal provided by the ALS sensor. The adjustment may be based on a pre-determined user condition, such as a color deficiency or blindness to a certain degree.

The ALS sensor may be a single photodiode configured for broadband measurements, a multi-cell photodiode, or even a camera having multiple pixels, including RGB pixels at each point of a two-dimensional (2D) array. With a single photodiode, ALS adjustments are based on single data points of ambient brightness and color. With a camera, ALS adjustments could more closely compensate for the portion of the real world that exists behind the display from the user's perspective.

In some embodiments, the camera may be used to assess, identify, and verify the ambient environment as initially detected by a single ALS sensor, or work in combination with the single photodiode when the ALS signal has low confidence or large fluctuations. For example, in some embodiments, the camera can be brought up to do a quick scene check to make sure the ambient environment is tracked accurately (e.g., identify a nighttime scene by catching the moon and the stars, a daytime scene by detecting a rising sun or a setting sun, and the like).

In some embodiments, the smart glass includes an electronically adjustable mechanism to adjust the transparency of one or both eyepieces, and combines a dimming adjustment with a previously calibrated display setting or an adjusted display setting, according to the ALS signal. In addition to a factory calibration, in some embodiments the smart glass may be configured for a field re-calibration under controlled lighting conditions (e.g., inside a charging case, and the like). In some embodiments, the user of the smart glass may manually adjust the brightness and color settings in the smart glass to her/his own preferences, independently of an automatic adjustment by the smart glass. To adjust the smart glass settings, user inputs may include voice commands, a cap touch slider, an input from a paired mobile device (e.g., smart phone), or a physical button to change between states and brightness levels when the user prefers to manually override an automatic setting. Accordingly, some embodiments adjust display settings based on lens tint and lens color (stock-keeping-unit, SKU) for normal, sun, and dim-adjusted lenses with different lens tints.

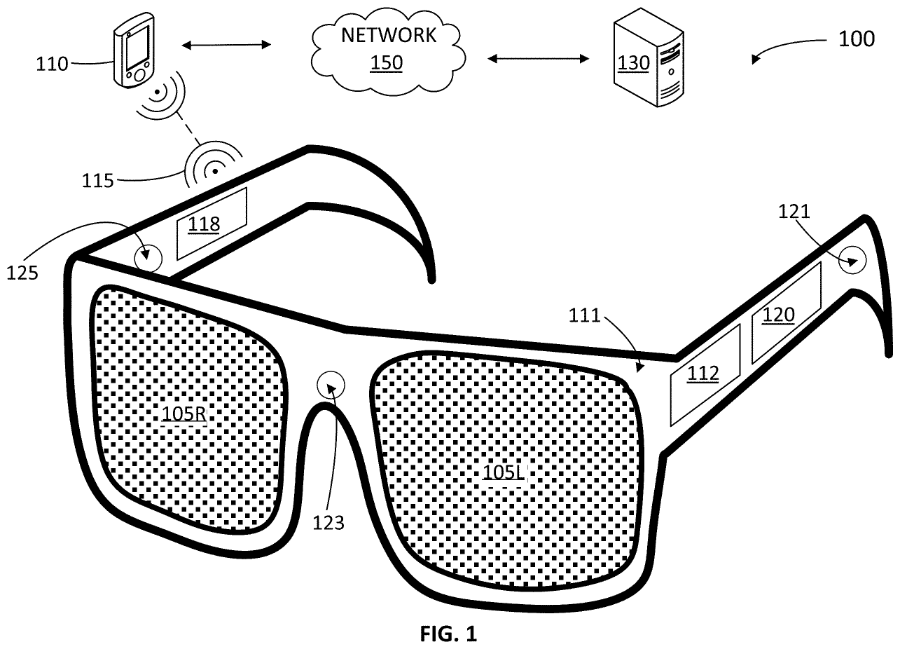

FIG. 1 illustrates a smart glass 100 including an ambient light sensor 125 for enhanced reality applications, according to some embodiments. Smart glass 100 includes a frame 111, holding left (105L) and right (105R) eyepieces (hereinafter, collectively referred to as “eyepieces 105”), a processor 112, a memory 120, and a communications module 118, and a forward-looking camera 123. In addition, and as part of a user interaction system, smart glass 100 may include a speaker/microphone 121 so that the user may provide voice commands and receive audio feedback. To assess environmental conditions, smart glass 100 may include one or more sensors 125 configured as ambient light sensors, acoustic detectors, and the like, e.g., an inertial motion unit —IMU— such as an accelerometer or gyroscope to help determine whether the smart glass is being used, or if it lays idle. In some embodiments, sensors 125 may include touch-sensitive controllers and sensors. In some embodiments, input from the touch sensors may be used in machine learning algorithms for gesture recognition. Ambient light sensors 125 may be configured to detect visible light (VIS, 450 nm-750 nm), ultraviolet light (UV, 200 nm to 450 nm wavelength), infra-red light (IR, 750 nm to 10 μm wavelength), or any other desired wavelength range. For example, in some embodiments, a UV detector may indicate the presence of direct sunlight (e.g., the user is outdoors and/or on a bright sunny day). In some embodiments, eyepieces 105 may include active components such as liquid crystal layers configured to provide a variable tint or dimming of eyepieces 105. Thus, the transparency of smart glasses 100 may be adjusted either automatically or by user control according to environmental conditions or user desire.

Memory circuit 120 stores instructions, which when executed by processor 112, cause smart glass 100 to perform at least some of the steps and operations disclosed herein. For example, the instructions stored in memory 120 may be part of an application installed in mobile device 110 and hosted by remote server 130. The application may be configured to pair up mobile device 110 with smart glass 100, retrieve data from it, and provide instructions and updates to smart glass 100. For example, the mobile application may include a user assistant to control and adjust settings in smart glass 100, and even to provide instructions and set configuration modes of smart glass 100. Additionally, camera 123 may capture an image or video of the forward view of the user. The image or video may be used by processor 112 or an application in mobile device 110 to review, inspect, and analyze the user's environment and arrive at a decision as to steps to take based on the environment. Further, in some embodiments, camera 123 may include a shutter configured to collect light from the forward view of the user at a pre-selected time rate or aperture, based on the amount of ambient light measured by the ALS sensor.

Communications module 118 generates electromagnetic (EM) signals to communicate with a mobile device 110 (e.g., a mobile device for the user of the smart glasses). Mobile device 110 may in turn communicate with a remote server 130 via a network 150. Remote server 130 may host an application installed in mobile device 110, through which the user may control, adjust settings, provide, collect, and process data collected by smart glass 100. Accordingly, communications module 118 may include radio and antenna hardware and software, to provide and receive wireless signals 115 from mobile device 110 and/or remote server 130.

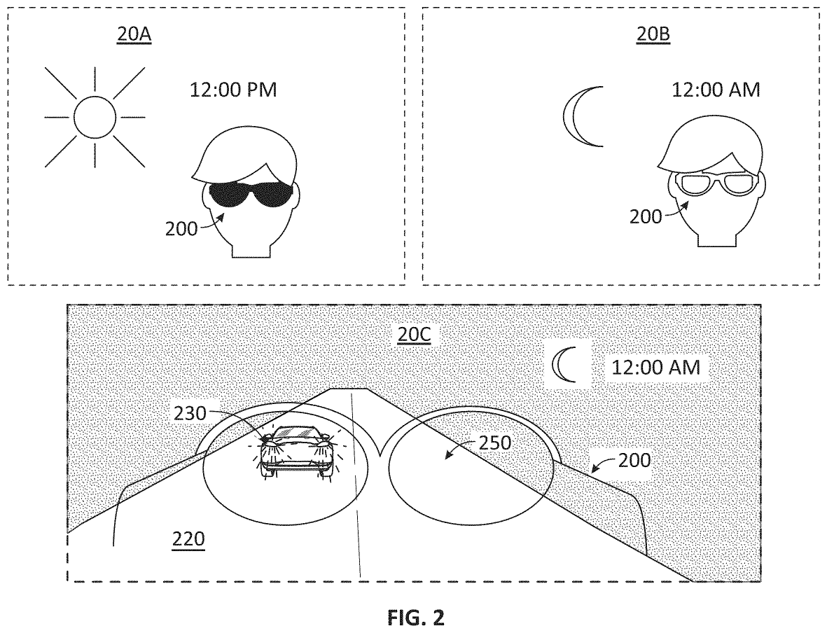

FIG. 2 illustrates several configurations 20A, 20B, and 20C (hereinafter, collectively referred to as “configurations 20”) of a smart glass 200 with an electronic control for transparency regulation, according to some embodiments. In a first configuration (20A), a user is in a bright outdoors (e.g., 12:00 PM) and the transparency of the eyepieces in the smart glasses is toned down. In a second configuration (20B), the user is outdoors, at night (e.g., 12:00 AM) in a poorly lit environment. Accordingly, in configuration B, it is desirable that the transparency of the smart glasses be higher. To achieve any of the outcomes in configurations 20A or 20B, the smart glasses may include ambient light sensors to assess the level of environmental lighting available.

A third configuration (20C) is somewhat more complex. The user is driving at night on a dark road 220, with low environmental lighting. When a car approaches in the opposite direction with headlights 230 ‘on,’ the smart glass may be configured to maintain the transparency level (or at least to not reduce transparency) so that the user can see the road clearly. To achieve this, the electric control of the smart glasses may apply artificial intelligence algorithms, in addition to ambient light sensors, to correctly read the situation and apply the appropriate action.

More generally, embodiments as disclosed herein include any one of configurations 20, complemented with IMU sensor data and touch sensing data to interpret the specific circumstances that the user is in, and to better assess the user's preferences and desires (e.g., the user is driving at night, taking an outdoors walk through a dark area, e.g., a forest, cloudy or stormy sky, and the like). Additionally, a mobile device communicatively coupled with the smart glass may identify, via GPS and other geolocation strategies, the time of day and the position of the sun relative to the user's head and orientation (which may be retrieved via IMU sensors). Accordingly, machine learning algorithms as disclosed herein may use geolocation information and the head orientation of the user therein to assess the user configuration of the smart glasses and better provide transparency level adjustments thereof.

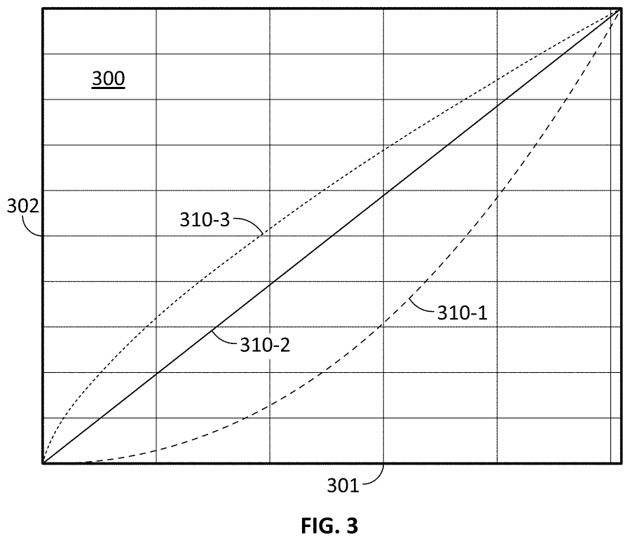

FIG. 3 illustrates a chart 300 including multiple scene-aware adaptive gamma curves 310-1, 310-2, and 310-3 (hereinafter, collectively referred to as “gamma curves 310”) for different ambient light configurations in a smart glass (cf. smart glasses 100 and 200), according to some embodiments. Gamma curves 310 provide a relative luminance value 302 (ordinates in chart 300), or power, associated with a given grayscale value 301 (abscissae in chart 300). In some embodiments, grayscale values 301 range from 0 to 256 (8-bit digitization). Gamma curves 310 may be used as calibration curves for digitizing grayscale values 301 under different ambient light configurations in a pixelated display. For example, gamma curve 310-1 is followed under standard illumination conditions. Gamma curve 310-2 is followed under a bright scene condition (cf. configuration 20A). And gamma curve 310-3 may be followed in a high contrast condition (cf. configuration 20C, or a full moon scene at night). Calibration curves 310 may be slightly different for each of the pixels in a display, and for each display in the smart glass. Moreover, calibration curves 310 may change with time and use of the smart glass.

In some embodiments, gamma curves of a display are adjusted dynamically as a function of the ambient brightness, to optimize additive contrast and visibility of a virtual scene or component relative to the real world.

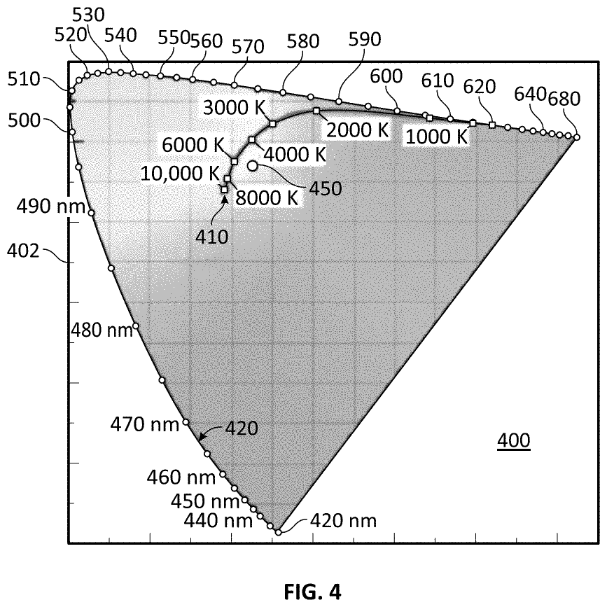

FIG. 4 illustrates a color gamut and chromaticity plot 400 for adjusting a Red, Green, and Blue (RGB) display in a smart glass (cf. smart glasses 100 or 200) to a given ambient light configuration, according to some embodiments. A correlated color temperature curve 410 is indicative of the different colors achieved by a perfect black body radiator at different temperatures (e.g., 1000K, 2000K, 3000K, 4000K, 6000K, 8000K, and 10,000K). Color gamut 400 indicates chromaticity coordinates 401 (u′, abscissae) and 402 (v′, ordinates) for each of a wide pallet of colors. For each color point, the (u′,v′) values may be converted into specific intensity values for each of the RGB pixels according to a calibration curve (cf. chart 300). The position of different wavelengths (e.g., spanning the range from 420 nm to 680 nm) is illustrated along an edge 420 of color gamut 400.

In some embodiments, a white point 450 may not only be used to power the display of the smart glass, but also to assess a color environment from an image captured by the camera in the smart glass (cf camera 123). For example, when the scene color temperature changes (warmer=more reddish, cooler=more bluish), according to an image collected by the camera, the white balance of the display may be changed to better match the scene. In some embodiments, color temperature curve 410 indicates different possible white points for the display that could be selected to match the ambient environment based on scene awareness. To achieve different white points, the display would adjust the mixing ratios of Red, Green, and Blue pixels. The exact amount of change may be indicated by a vector in (u′,v′) coordinates, which is then translated into RGB pixel values according to the calibration curves.

In some embodiments, and in a similar manner, the display may limit the color temperature as a function of time of day, inducing warmer colors at night (e.g., by shifting neutral color points along the higher temperature direction in the correlated color temperature curve). Accordingly, some embodiments may include a bedtime setting where the display is either off or lowers the brightness significantly in order to not keep the user stimulated to be awake.

Based on the ambient brightness, some embodiments enable a “dark” mode where the display has a lower brightness with warmer colors, depending on the time of day for enhanced comfort. In addition, the “dark” mode may be manually enabled by the user on a one-time basis, or pre-programed on a desired schedule, or it may be automatically set by the smart glass.

In some embodiments, color gamut 400 may be used to display over world colors to help users with color blindness. For example, a certain hue may be more distinguishable to a user having a given physiological condition, and so the display may be adjusted in the direction of that hue, as a mapping in color gamut 400. The mapping may be a shift for a point in color gamut 400 (true world color) to a new point (user-adapted color) in a given direction and by a given distance. In some embodiments, the mapping may include a different shift (in length and direction), for each point in color gamut 400. Accordingly, in some embodiments, the mapping may be a two-dimensional (2D) vector field associated with color gamut 400. In some embodiments, a mapping in gamut 400 as described herein may be used to adapt colors from a true-word representation to a virtual world representation, characterized by user-selected or context-derived attributes (e.g., oneiric, reminiscing, psychedelic, surreal, ethereal, apocalyptic, and the like).

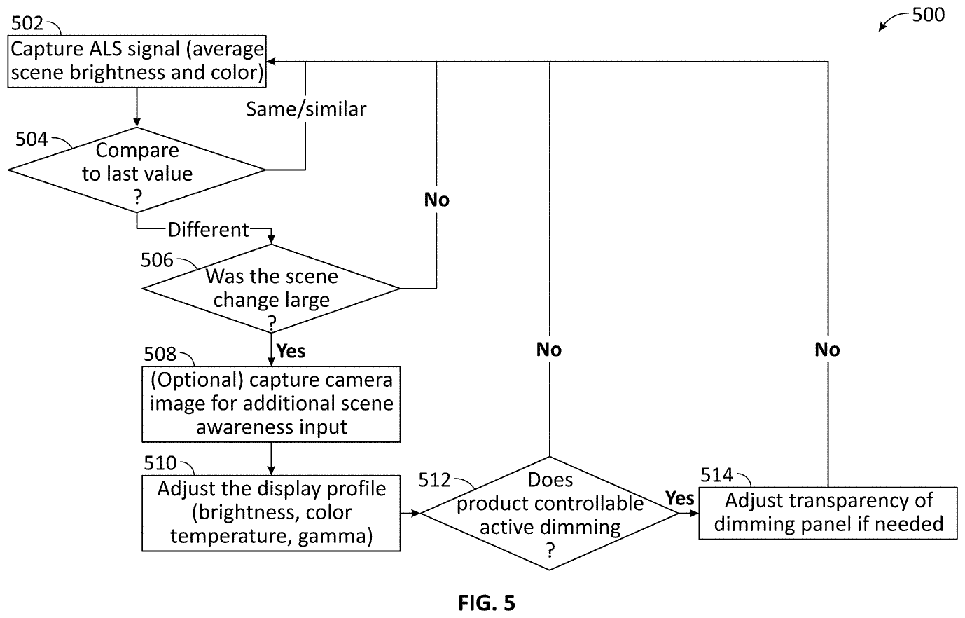

FIG. 5 illustrates a flow chart indicating steps in a method 500 for adjusting an RGB display in a smart glass according to an ambient light configuration, according to some embodiments. In some embodiments, at least one or more of the steps in method 500 may be performed by a processor executing instructions stored in a memory as in any of the devices disclosed herein (cf. FIG. 1). For example, any one of the processor and the memory may be part of any one of the smart glass, the mobile device, or the remote server. In addition, the instructions in the memory may include any one of a machine learning algorithm, or an artificial intelligence algorithm, or a linear or non-linear regression algorithm, including a neural network and the like. The smart glass device may include an ALS sensor and a camera, as disclosed herein (cf. FIG. 1). Moreover, in some embodiments, a method consistent with the present disclosure may include at least one of the steps in method 500 performed alone or in combination with any other step, simultaneously, quasi-simultaneously, or overlapping in time.

Step 502 includes capturing a new ALS signal from an ALS sensor. In some embodiments, step 502 includes determining an average scene brightness and color.

Step 504 includes comparing the new ALS signal with an old ALS signal. In some embodiments, the old ALS signal may be the most recent ALS signal in storage.

When the new ALS signal is different from the old ALS signal (cf. step 504), step 506 includes determining whether the change in the ALS signal is larger than a pre-selected threshold. When the change in the ALS signal is not larger than the pre-selected threshold, method 500 is repeated from step 502.

When the change in the ALS signal is larger than the pre-selected threshold, step 508 includes collecting, with the camera, an image for additional scene awareness input.

Step 510 includes adjusting the display profile for brightness, color, temperature, and gamma (cf FIGS. 3-4) based on a desired value corresponding to the new ALS signal.

Step 512 includes determining whether the display in the smart glass includes a controllable active dimming feature. When the display does not include the controllable active dimming feature, method 500 is repeated from step 502.

When the display includes a controllable dimming feature according to step 512, step 514 includes adjusting the transparency of the eyepiece that includes the display according to the desirable intensity of the image in the display, based on the desired value corresponding to the ALS signal.

Method 500 is repeated for a new measurement of the ALS signal. In some embodiments, method 500 is repeated by querying the ALS sensor at a pre-selected frequency. In some embodiments, method 500 may include receiving the ALS signal from the ALS sensor continuously, and only triggering steps 510-514 when a change higher than the pre-selected threshold is observed. In some embodiments, method 500 may also include updating the pre-selected threshold according to user configuration and desires. In yet other embodiments, method 500 may include receiving, form the remote sensor, an updated value for the pre-selected threshold.

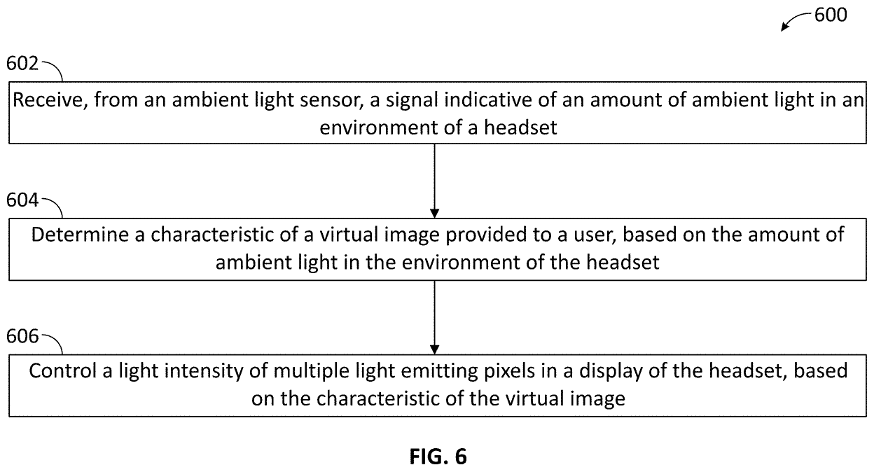

FIG. 6 is a flowchart illustrating steps in a method 600 for controlling a display in a headset based on an ambient light measurement, according to some embodiments. In some embodiments, at least one or more of the steps in method 600 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 600 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication —NFC— and the like). In some embodiments, a method consistent with the present disclosure may include one or more steps from method 600 performed in any order, simultaneously, quasi-simultaneously, or overlapping in time. Accordingly, the headset in method 600 may include a left eyepiece and a right eyepiece mounted on a frame, a display in at least one of the left eyepiece or the right eyepiece, the display including an array of multiple light emitting pixels, an ambient light sensor to measure an amount of ambient light, and a processor configured to control a light intensity of the light emitting pixels based on the amount of ambient light.

Step 602 includes receiving, from an ambient light sensor, a signal indicative of an amount of ambient light in an environment of a headset.

Step 604 includes determining a characteristic of a virtual image provided to a user, based on the amount of ambient light in the environment of the headset.

Step 606 includes controlling a light intensity of multiple light emitting pixels in a display of the headset, based on the characteristic of the virtual image. In some embodiments, step 606 includes adjusting the light intensity of multiple light emitting pixels based on the amount of ambient light and a calibration image stored in a memory circuit. In some embodiments, step 606 includes evaluating a chromaticity value from an image collected with a camera. In some embodiments, step 606 includes adjusting a relative intensity of a plurality of red emitting pixels, a plurality of green emitting pixels, and a plurality of blue emitting pixels based on a chromaticity value associated with the amount of ambient light. In some embodiments, step 606 includes adjusting a relative intensity of a plurality of red emitting pixels, a plurality of green emitting pixels, and a plurality of blue emitting pixels based on a chromaticity value, the amount of ambient light, and a color deficiency in a user perceptivity. In some embodiments, step 606 includes adjusting a transparency controller to dim an amount of transmitted light through an eyepiece in the headset, based on the amount of ambient light. In some embodiments, step 606 includes controlling the light intensity of multiple light emitting pixels according to a thermal gamut when the amount of ambient light indicates a nighttime usage. In some embodiments, step 606 includes controlling the light intensity of multiple light emitting pixels based on the amount of ambient light and a tint of an eyepiece in the headset.

### Hardware Overview

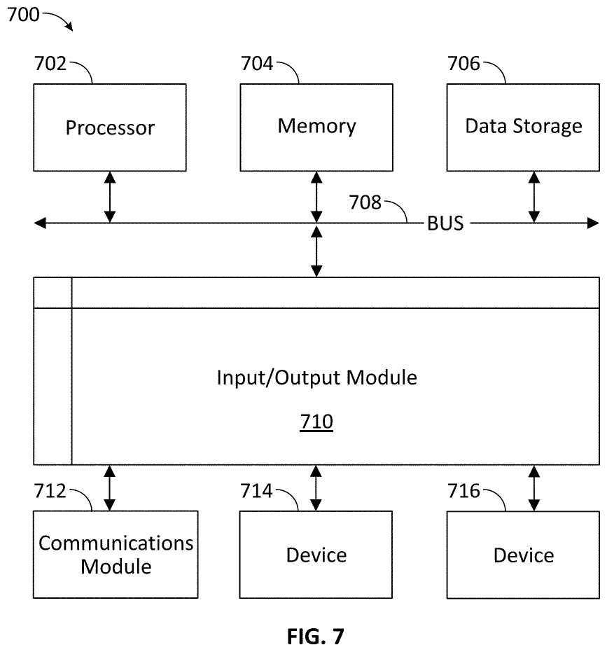

FIG. 7 is a block diagram illustrating an exemplary computer system 700 with which smart glass 100 of FIG. 1, and methods 500 and 600 can be implemented, according to some embodiments. In certain aspects, computer system 700 may be implemented using hardware or a combination of software and hardware, either in a dedicated server, or integrated into another entity, or distributed across multiple entities. Computer system 700 may include a desktop computer, a laptop computer, a tablet, a phablet, a smartphone, a feature phone, a server computer, or otherwise. A server computer may be located remotely in a data center or be stored locally.

Computer system 700 includes a bus 708 or other communication mechanism for communicating information, and a processor 702 (e.g., processor 112) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled with bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, input/output module 710 is configured to connect to a plurality of devices, such as an input device 714 and/or an output device 716. Exemplary input devices 714 include a keyboard and a pointing device, e.g., a mouse or a trackball, by which a consumer can provide input to the computer system 700. Other kinds of input devices 714 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 716 include display devices, such as an LCD (liquid crystal display) monitor, for displaying information to the consumer.

According to one aspect of the present disclosure, wearable devices 100 can be implemented, at least partially, using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A device, comprising:
a left eyepiece and a right eyepiece mounted on a frame;
a display in at least one of the left eyepiece or the right eyepiece, the display comprising an array of multiple light emitting pixels;
an ambient light sensor to measure an amount of ambient light; and
a processor configured to control a light intensity of the light emitting pixels based on the amount of ambient light.

2. The device of claim 1, wherein the ambient light sensor includes one or more photodiodes.

3. The device of claim 1, further comprising a memory storing a gamma curve calibrating the light intensity of the light emitting pixels to provide a desired luminance for the amount of ambient light.

4. The device of claim 1, further comprising a memory storing a calibration image, wherein the processor is configured to adjust the light intensity of the light emitting pixels based on the amount of ambient light and the calibration image.

5. The device of claim 1, wherein the ambient light sensor includes a camera configured to collect an image of a front view, and the processor is configured to evaluate a chromaticity value from an image collected with the camera, and to control the light intensity of the light emitting pixels based on the amount of ambient light and the chromaticity value.

6. The device of claim 1, wherein the light emitting pixels include multiple red emitting pixels, multiple green emitting pixels, and multiple blue emitting pixels, wherein the processor is configured to adjust a relative intensity of the red emitting pixels, the green emitting pixels and the blue emitting pixels based on a chromaticity value associated with the amount of ambient light.

7. The device of claim 1, wherein the light emitting pixels include multiple red emitting pixels, multiple green emitting pixels, and multiple blue emitting pixels, wherein the processor is configured to adjust a relative intensity of the red emitting pixels, the green emitting pixels and the blue emitting pixels based on a chromaticity value, the amount of ambient light, and a color deficiency in a user perceptivity.

8. The device of claim 1, wherein the left eyepiece and the right eyepiece further include a transparency controller to dim an amount of transmitted light through the left eyepiece and the right eyepiece, wherein the processor is configured to adjust the transparency controller based on the amount of ambient light.

9. The device of claim 1, wherein the processor further controls the light intensity of the light emitting pixels according to a thermal gamut when the amount of ambient light indicates a nighttime usage.

10. The device of claim 1, wherein at least one of the left eyepiece and the right eyepiece is tinted, and the processor is configured to control a light intensity of the light emitting pixels based on the amount of ambient light and a tint of the left eyepiece or the right eyepiece.

11. A computer-implemented method, comprising:
receiving, from an ambient light sensor, a signal indicative of an amount of ambient light in an environment of a headset;
determining a characteristic of a virtual image provided to a user, based on the amount of ambient light in the environment of the headset; and
controlling a light intensity of multiple light emitting pixels in a display of the headset, based on the characteristic of the virtual image.

12. The computer-implemented method of claim 11, wherein controlling a light intensity of multiple light emitting pixels in the display comprises adjusting the light intensity of multiple light emitting pixels based on the amount of ambient light and a calibration image stored in a memory circuit.

13. The computer-implemented method of claim 11, wherein controlling a light intensity of multiple light emitting pixels in the display comprises evaluating a chromaticity value from an image collected with a camera.

14. The computer-implemented method of claim 11, wherein controlling a light intensity of multiple light emitting pixels in the display comprises adjusting a relative intensity of a plurality of red emitting pixels, a plurality of green emitting pixels and a plurality of blue emitting pixels based on a chromaticity value associated with the amount of ambient light.

15. The computer-implemented method of claim 11, wherein controlling a light intensity of multiple light emitting pixels in the display comprises adjusting a relative intensity of a plurality of red emitting pixels, a plurality of green emitting pixels and a plurality of blue emitting pixels based on a chromaticity value, the amount of ambient light, and a color deficiency in a user perceptivity.

16. The computer-implemented method of claim 11, wherein controlling a light intensity of multiple light emitting pixels in the display comprises adjusting a transparency controller to dim an amount of transmitted light through an eyepiece in the headset, based on the amount of ambient light.

17. The computer-implemented method of claim 11, wherein controlling a light intensity of multiple light emitting pixels in the display comprises controlling the light intensity of multiple light emitting pixels according to a thermal gamut when the amount of ambient light indicates a nighttime usage.

18. The computer-implemented method of claim 11, wherein controlling a light intensity of multiple light emitting pixels in the display comprises controlling the light intensity of multiple light emitting pixels based on the amount of ambient light and a tint of an eyepiece in the headset.

19. The computer-implemented method of claim 11, further comprising selecting a white point for the display based on a correlated color temperature to match an ambient environment based on a scene awareness in addition to the amount of ambient light in the environment of a headset.

20. The computer-implemented method of claim 11, further comprising adjusting a white point for the display based on a color temperature limited by a time of day and a temperature value, in addition to the amount of ambient light in the environment of the headset.
